(19) United States
(12) Patent Application Publication
(10) Pub. No.: US 2024/0118904 A1
(43) Pub. Date: Apr. 11, 2024

(54) METHODS, SYSTEMS, ARTICLES OF MANUFACTURE AND APPARATUS TO ACCELERATE SERVICE EXECUTION

(71) Applicant: Intel Corporation, Santa Clara, CA (US)

(72) Inventors: Kishore Kasichainula, Phoenix, AZ (US); Kar Leong Wong, Folsom, CA (US); Nagaramya Jayagopal, Karlsruhe (DE); Shravan Suryanarayana, Karlsruhe (DE)

(21) Appl. No.: 18/545,739

(22) Filed: Dec. 19, 2023

(51) Int. Cl. G06F 9/4401; G06F 3/16

(52) U.S. Cl. CPC G06F 9/4403; G06F 3/16

(57) ABSTRACT

Systems, apparatus, articles of manufacture, and methods are disclosed to accelerate service execution. An example apparatus includes a system including first circuitry to initialize during a boot time period, and at least one of audio circuitry and networking circuitry to complete initialization and perform a service before expiration of the boot time period.

### FIELD OF THE DISCLOSURE

This disclosure relates generally to computing platforms and, more particularly, to methods, systems, articles of manufacture and apparatus to accelerate service execution.

### BACKGROUND

Computing platforms are ubiquitous in consumer electronics, information technology systems, safety systems, and defense systems. The computing platforms may include subsystems and/or disparate circuitry that work together to provide services.

### BRIEF DESCRIPTION OF THE DRAWINGS

FIG. 1 is a block diagram of an example environment in which example circuitry operates to accelerate service execution in a manner consistent with teachings of this application.

FIG. 2 is a block diagram of an example implementation of the example platform initialization circuitry of FIG. 1 to accelerate service execution.

FIGS. 3-7 are flowcharts representative of example machine-readable instructions and/or example operations that may be executed, instantiated, and/or performed by example programmable circuitry to implement the platform initialization circuitry of FIGS. 1 and/or 2.

FIG. 8 is a block diagram of an example processing platform including programmable circuitry structured to execute, instantiate, and/or perform the example machine-readable instructions and/or perform the example operations of FIGS. 3-7 to implement the platform initialization circuitry 150 of FIGS. 1 and/or 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine-readable instructions of FIGS. 3-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Computing platforms, such as a system-on-chip (SoC) device, facilitate service execution, such as services (e.g., tasks, routines, etc.) related to entertainment, safety and/or productivity. Some known services utilize a number of different circuits of an SoC to satisfy an objective, in which the different circuits (e.g., sub-circuits) are communicatively connected via one or more bus architectures and/or wireless interfaces. A requested service is operational after all of the different circuits has been booted and/or otherwise completed an initialization process (e.g., initialized after a powered-off state). As used herein, “initialization” or “initialize” is a process, operation or task with two or more phases, a first phase that begins the process (e.g., after a trigger, a request, etc.), and a second phase indicative of completion of the initialization process (e.g., completion of power-on, power-up, power-on-self-test (POST), etc.). As used herein, the past tense form “initialized” represents an initialization process that has completed both the first and second phases of the initialization process. As such, the requested service is delayed from operation until after a period of time (e.g., a boot time period) elapses to allow multiple different circuits to complete the initialization process. As used herein, a boot time period represents an amount of time that elapses from an initial power-on request of the SoC (or other computing platform) to a point in time where an operating system of the SoC is in an operational phase.

Generally speaking, an integrated circuit (IC) package includes any number and/or types of circuitry that is encased and/or otherwise packaged as a unit (e.g., a device, such as an IC chip). While examples disclosed herein refer to SoCs, such examples are not limited thereto. A known SoC facilitates service execution after a boot process that culminates to an executing operating system (OS). The OS becomes fully operational after a power-on self test (POST) followed by basic input/output system (BIOS) tasks to manage data flow between the OS and attached devices and/or peripherals. Known SoCs employ OS kernel drivers to complete the initialization of particular portions (e.g., circuits, systems) of the SoC, which requires a fully operational OS ahead of such initialization activities.

The amount of time required to boot an SoC to an OS is referred to herein as the boot time period, or a “boot latency.” Major contributors that extend the boot latency include memory initialization (e.g., configuration of memory reference code (MRC) to complete the initialization of double data rate (DDR) synchronous dynamic random-access memory (SDRAM)), OS loading and memory copies of data. To achieve service execution performance metrics within a particular threshold period of time, some SoCs utilize auxiliary circuits and/or external-platform solutions that are dedicated for specific tasks without reliance upon a fully functional OS. For example, some auxiliary circuits are hardwired to a trigger input to instantiate the desired service in response to activation of the ignition switch, thereby causing the chime service to occur in a manner independent of the SoC boot schedule. The use of auxiliary and/or otherwise additional circuits contributes to an increased bill-of-materials (BoM) for the SoC, and adds weight to one or more cable harnesses for the SoC. In particular, the automotive industry is challenged with the realization that wiring harnesses in vehicles are the third heaviest component (behind the vehicle chassis and engine). As vehicle features advance, an increase in corresponding sensors, controls and interfaces with similarly increased bandwidth requirements further add complexity, weight and cost to the vehicle. Additionally, as vehicle features advance, a corresponding memory footprint for such features increases, thereby consuming additional time for memory loading activities (e.g., audio samples being copied from kernel space to user space, etc.), and device-to-device bandwidth increases.

Some use cases disclosed herein employ SoCs in environments where particular services must operate within a threshold period of time that is less than the amount of time required for an SoC to boot to the OS. For example, some automotive use cases include SoCs communicatively connected to an ignition switch that starts a vehicle. In some such examples, the SoC is to cause a chime to be emitted (e.g., emitted from a vehicle infotainment system and/or speakers) within a threshold period of time after the ignition switch is activated (e.g., pressed by a user). In some examples the threshold period of time is regulated and/or otherwise imposed by jurisdictional laws and/or safety regulations. In some examples the threshold period of time is regulated by a standards organization/consortium that manufacturers comply with to achieve particular certification for their product(s).

While some examples disclosed herein may apply to any industry and/or use case scenario, some examples disclosed herein will discuss the needs of the automotive industry in a non-limiting manner Some examples disclosed herein to illustrate acceleration of service execution include an automotive platform that includes (a) a network controller and (b) an audio system, as described in further detail below. For instance, the automotive industry has adopted a fast-boot feature with the advent of audio/video bridging (AVB) standards (e.g., IEEE 1722-“IEEE Standard for a Transport Protocol for Time-Sensitive Applications in Bridged Local Area Networks,” in IEEE Std 1722-2016 (Revision of IEEE Std 1722-2011), vol., no., pp. 1-233, 16 Dec. 2016) associated with time sensitive networking (TSN) standards (e.g., IEEE 802.1-“IEEE Standard for Local and metropolitan area networks—Bridges and Bridged Networks,” in IEEE Std 802.1Q-2014 (Revision of IEEE Std 802.1Q-2011), vol., no., pp. 1-1832, 19 Dec. 2014). Such example standards integrate TSN-capable Ethernet controllers to facilitate precise scheduling of data, such as audio signal propagation through vehicle speaker systems and infotainment systems in a time-sequenced manner In some examples, standards require that an automotive Ethernet device (AED) must be ready to operate within 800 mSec of ignition switch activation, and an audio chime must be transmitted within 1.21125 seconds of that ignition switch activation. As used herein, an AED is considered ready to operate when it is able to receive and transmit Ethernet packets and all physical (PHY) and medium access control (MAC) components are operational. Additionally, automotive standards require an audio response latency to be within 1 mSec, which is measured from the time an audio sample is received by an audio application to the time an AED transmits that audio sample over the network (or vice versa).

Some disclosed examples herein reduce the burden of added cable weight and contribute to improvements in fuel economy and/or other “green” initiatives. In some examples disclosed herein, services may be instantiated and/or otherwise executed faster than known techniques that require a fully operational OS. As used herein, services include non-boot tasks, such as operations that are unassociated with booting an SoC (or any other computing device/platform). Services (non-boot tasks) include rending audio, video, alarm systems, motion detection, etc. Some examples disclosed herein employ a forked boot flow and peer-to-peer data transfer techniques to prioritize initialization phases and/or booting tasks corresponding to particular SoC portions (e.g., an IC package containing circuits, sub-circuits, devices (e.g., devices within the circuits), communication busses, bus fabrics, etc.) that are needed for the particular service of interest to execute. Some examples disclosed herein cause initialization processes corresponding to particular SoC portions in a non-default sequence in favor of other SoC portions that do not directly impact execution of the service of interest.

Some examples disclosed herein facilitate a forked boot flow by employing a microcontroller or other processor circuitry on an SoC to initialize an Ethernet controller to bring up a network link in parallel with a normal boot flow of the SoC. Other SoC portions that do not impact the service of interest complete the initialization process in that normal boot flow. Some examples disclosed herein store firmware in a non-volatile memory (e.g., flash memory) for first SoC portions (e.g., Ethernet circuitry, audio circuitry) that are to be initialized ahead of second SoC portions (e.g., video circuitry). Typical boot flow requires MRC services prior to SoC portion initialization processes begin, but some examples disclosed herein avoid any need for MRC services by invoking the microcontroller to retrieve particular firmware from the non-volatile memory for initialization of the first (e.g., prioritized) SoC portions. Additionally, some examples disclosed herein re-purpose a bus fabric of the SoC to enable device-to-device communication of audio data thereby enabling the ability for an audio circuit to retrieve audio data (e.g., a chime) from the non-volatile memory, process the audio data (e.g., apply one or more digital signal processing (DSP) operations, and send the processed audio data to the network circuitry for distribution to audio speakers before full booting of the SoC is completed.

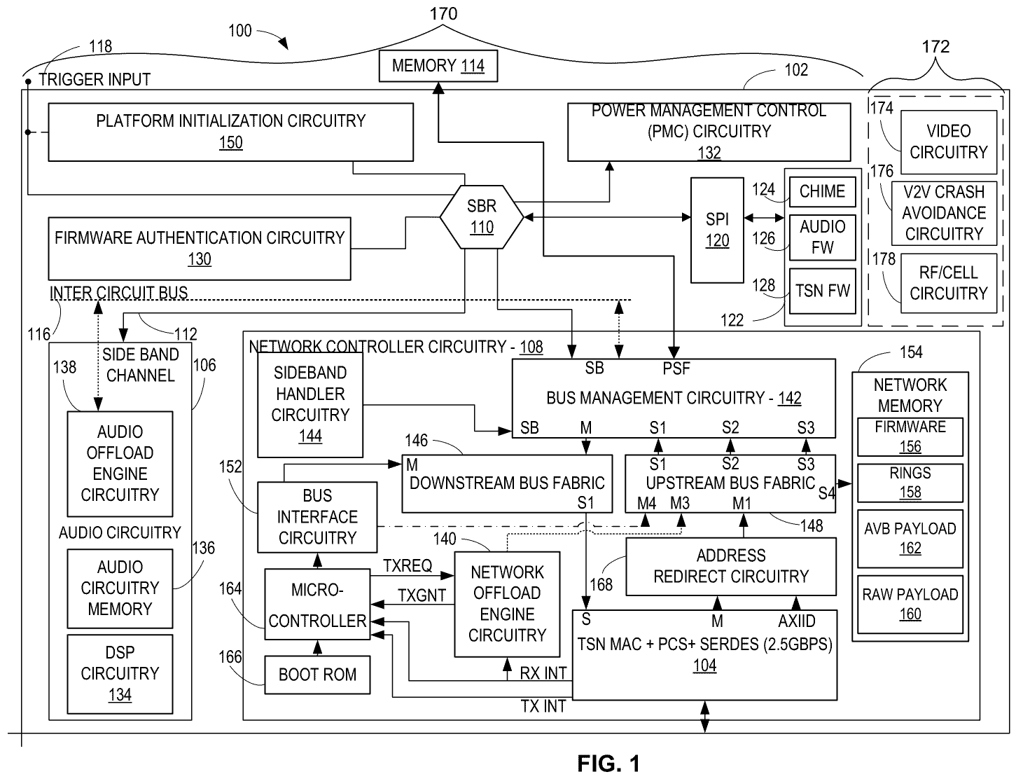

FIG. 1 is a block diagram of an example environment 100 in which an example SoC 102 operates to accelerate service execution. In the illustrated example of FIG. 1, the environment 100 is expected to cause a chime to be played on speakers (e.g., speakers connected to a network connected infotainment system) that are communicatively connected to a media access controller (MAC) (e.g., Ethernet network) 104. The example SoC 102 includes example audio circuitry 106 and example network controller circuitry 108, both of which are communicatively connected to an example side band router (SBR) 110 via any type of bus.

The illustrated example SoC 102 of FIG. 1 includes first boot path circuitry and/or devices 170 and a second boot path circuitry and/or devices 172. The example first boot path circuitry 170 corresponds to those particular circuits and/or devices that enable a particular service of interest to execute faster/earlier than would otherwise be possible with a default boot operation of the SoC 102. The example second boot path circuitry 172 corresponds to those particular circuits and/or devices that have no influence or effect on the particular service of interest to be executed in the accelerated manner Assuming as an example that the service of interest is to play an audio chime, the second boot path circuitry 172 does not include circuits and/or devices that assist in the objective of playing the audio chime. Instead, the example second boot path circuitry 172 includes example video circuitry 174, example vehicle-to-vehicle (V2V) crash avoidance circuitry 176, and radio frequency (RF)/cell circuitry 178.

In the illustrated example of FIG. 1, the SBR 110 is communicatively connected to a side band bus 112. Communication between the example audio circuitry 106 and the example network controller circuitry 108 may occur by way of example primary scalable fabric (PSF), sometimes referred to herein as an inter circuit bus 116. The typical operation of the inter circuit bus 116 involves DDR memory cooperation to store transmitted data from various SoC devices before it reaches its intended destination, but such DDR memory is not operational at the beginning of any initialization (boot) of the SoC 102. Additionally, the intermediate task of sending data to DDR memory consumes time before such data is then re-transmitted from the DDR memory to one or more destination devices of the SoC. However, the example inter circuit bus 116 of FIG. 1 facilitates communication between such subcircuits (e.g., the audio circuitry 106 and the network controller circuitry 108) without any need for DDR availability and/or cooperation. In other words, the example inter circuit bus 116 enables direct communication without involvement by the DDR, thereby reducing communication latency.

To orchestrate an alternate initialization order for devices (e.g., the audio circuitry 106, the network controller circuitry 108, the MAC 104, etc.), the example SoC 102 includes platform initialization circuitry 150. In some disclosed examples, the platform initialization circuitry 150 is communicatively connected to an example trigger input 118, such as a vehicle ignition switch. The platform initialization circuitry 150 of this example is one of the first devices of the SoC 102 to begin operations during SoC device initialization. The platform initialization circuitry 150 supports execution of a prioritized service earlier than would otherwise occur if all devices (e.g., all circuitry, sub-circuitry, etc.) of the SoC were initialized in the prior known manner (e.g., power-on-self-test of all devices followed by BIOS initialization and initialization of memory 114). An example implementation of the example platform initialization circuitry 150 is discussed in further detail below.

The example SoC 102 of FIG. 1 includes an example serial peripheral interface (SPI) 120 communicatively connected to example non-volatile memory (NVM) 122. The example NVM may be any type of memory, such as flash memory. Typical platforms (e.g., such as the example SoC 102) permit data transfers between subsystems (e.g., the example audio circuitry 106 and the example network controller circuitry 108) after a full boot, which requires DDR memory that must first be initialized via MRC procedures. However, the example SoC 102 of FIG. 1 stores firmware in the NVM 122 to facilitate on-platform authentication and initialization of SoC devices in a manner independent of any DDR state (e.g., off-SoC memory that would first require initialization). In the illustrated example of FIG. 1, the NVM 122 includes chime data 124, audio firmware 126 and TSN firmware 128. The example SoC 102 also includes firmware authentication circuitry 130 to authenticate firmware stored in the example NVM 122 prior to use. The example SoC 102 also includes power management control (PMC) circuitry 132 to control an order in which devices of the SoC 102 are to receive power (e.g., a power sequence). For instance, if the SoC included other devices associated with video services, the example PMC circuitry 132 may adjust a sequence in which those devices receive power because they do not support a prioritized audio chime service that must occur within approximately 1.2 seconds after the trigger input 118 becomes active. Stated differently, example sequence adjustments temporarily prevent relatively lower prioritized devices from powering-up, thereby reducing latency for the SoC 102 to perform an accelerated and/or otherwise prioritized task (e.g., cause a chime to be audibly rendered). In some examples, particular devices to be powered-up in a particular sequence and/or priority are identified in firmware (e.g., firmware specific to audio circuitry, firmware specific to network circuitry, etc.).

The example audio circuitry 106 of FIG. 1 includes digital signal processing (DSP) circuitry 134, audio circuitry memory 136, and audio offload engine circuitry 138. The example audio offload engine circuitry 138 is communicatively connected to example network offload engine circuitry 140 via the example inter circuit bus 116, which allows the example audio circuitry 106 to communicate directly with the example network controller circuitry 108 (e.g., rather than communicate through one or more intermediary devices, such as the example memory 114 which may not be operational within the requisite 1.2 seconds after an ignition key trigger (trigger input) 118).

The example network controller circuitry 108 includes example bus management circuitry 142 to facilitate bus communications via the example side band busses 112 and the example inter circuit bus 116. The example network controller circuitry 108 includes example side band handler circuitry 144, an example downstream bus fabric 146, an example upstream bus fabric 148, and example bus interface circuitry 152. The example network controller circuitry 108 includes network memory 154, which stores firmware 156, rings 158 (e.g., descriptor rings), raw payload data 160, and AVB payload data 162.

The example network controller circuitry 108 includes an example microcontroller 164 (or other processor circuitry such as a microprocessor, etc.) and an associated boot read only memory (ROM) 166 for its initialization. The example network controller circuitry 108 also includes example address redirect circuitry 168 to steer any direct memory access (DMA) transactions from the example MAC 104. Stated differently and as described in further detail below, in the event network communications arrive from the example MAC 104 prior to the point at which the SoC 102 is fully initialized, then the DMA destinations (e.g., the memory 114) will not be functional and/or otherwise available. As such, the example address redirect circuitry 168 redirects such addresses to the network memory 154 instead of to the DMA destinations.

Firmware for the example audio circuitry 106, the example microcontroller 164 and the example MAC 104 are stored (e.g., preloaded) in the example NVM 122. As such, upon an ignition trigger input 118 the example firmware authentication circuitry 130 (e.g., a converged security engine (CSE)) authenticates the firmware and copies it to the audio circuitry memory 136 and the network memory 154 for later use. In particular, the firmware can immediately be executed by the respective devices without needing to wait for other portions of the SoC 102 to be fully operational. For example, there is no need to wait for completion of initialization of the off-SoC memory 114 or any OS drivers. As a result, boot latency is substantially reduced (e.g., to a few hundred milliseconds) rather than waiting for the relatively lengthy MRC initialization and OS loading procedures that occur during default boot operations in known systems. The example microcontroller 164 of the network controller circuitry 108 of FIG. 1 performs any number of network-oriented functions, such as generalized precision time protocol (gPTP) functions, AVB scheduling and/or audio/video transport protocol (AVTP) packet processing functions. An audio sample, such as a chime, is obtained from the example audio circuitry 106 through the example inter circuit bus 116 (e.g., the peer-to-peer primary scalable fabric (PSF)) via the example offload engine circuitry (e.g., the example audio offload engine circuitry 138 and the example network offload engine circuitry 140). Based on the microcontroller 164 firmware, the microcontroller 164 generates descriptor rings, packet scheduling and adding or removing AVTP packet headers. For instance, the example MAC 104 performs transmission and reception of packets without knowing where the data is coming from, but the example address redirect circuitry 168 steers any DMA transactions toward the example network memory 154 instead of DDR memory, which is not yet operational. Once playback of the audio chime is completed, normal BIOS initialization tasks/processes may continue to bring any remaining portions of the SoC 102 up. In other words, the forked boot paths merge.

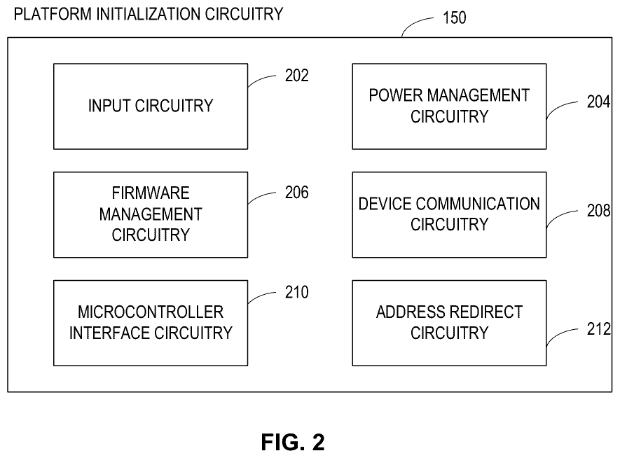

FIG. 2 is a block diagram of an example implementation of the platform initialization circuitry 150 of FIG. 1. The platform initialization circuitry 150 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the platform initialization circuitry 150 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers to provide a virtual execution environment for software instantiating operation of the corresponding circuitry.

In the illustrated example of FIG. 2, the platform initialization circuitry 150 includes input circuitry 202 to respond to signals indicative of a request to initiate the example SoC 102. In some examples, the signal indicative of the request to initiate the example SoC 102 is the result of a user pressing a vehicle ignition switch or turning an ignition key. The example input circuitry 202 is communicatively connected to the example trigger input 118. In some examples, the input circuitry 202 is also communicatively connected to the example MAC 104 to determine whether network communications have arrived from a network (e.g., a vehicle network connected to an infotainment system), which allows the example SoC 102 to respond to either a network-sourced request for a service or a request for service from the trigger input 118, as described in further detail below.

The example platform initialization circuitry 150 includes example power management circuitry 204 to control which devices of the SoC 102 receive power. For instance, while the example SoC 102 of FIG. 1 includes a particular arrangement of devices (e.g., the example audio circuitry 106, the example network controller circuitry 108, the example firmware authentication circuitry 130, etc.), some examples of the SoC 102 may include any number and/or type of additional or alternate devices. In some examples, the SoC 102 may include devices associated with video processing, which are unnecessary to satisfy an objective of generating a chime within a threshold period of time based on particular standards (e.g., industry standards and/or laws).

The example platform initialization circuitry 150 includes example firmware management circuitry 206 to manage tasks associated with firmware authentication and initialization for any number of devices of the example SoC 102. In some examples, the firmware management circuitry 206 searches available non-volatile memory that may be present on the example SoC 102 for stored instances of firmware associated with devices thereon. In some examples, firmware stored on the SoC 102 includes instructions for the example firmware authentication circuitry 130 (sometimes referred to as a converged security engine (CSE)) that a source for other firmware is to be found in the NVM 122 rather than typical and/or otherwise default locations. In some examples disclosed herein, if the platform initialization circuitry 150 detects one or more flags or data elements in the NVM 122 indicative of a request for a forked boot operation (e.g., a flag named “Fork Boot” and a corresponding value of “1” or “TRUE”), then alternate and/or otherwise non-default SoC boot operations will occur. As used herein, a “forked boot” causes a first (primary) boot path to occur in parallel with a second (secondary) boot path, in which the first boot path is prioritized to execute a service of interest (e.g., a task, such as playing a chime and/or otherwise transmitting a chime via a network to cause the chime to be played on an infotainment system) within a threshold period of time before the secondary boot path completes. After the first boot path and the second boot path complete their operations (e.g., initialization operations, accelerated service execution operations, etc.), the boot paths merge and/or otherwise revert to normal operations of the example IC package (e.g., the example SoC, a device, etc.). To the extent that circuitry and/or devices corresponding to the second boot path (e.g., the second boot path circuitry 172) can continue in parallel without interrupting the circuitry and/or devices corresponding to the first boot path, then such circuitry and/or devices may proceed to follow their booting operations (e.g., default power-on sequences). For example, after the first boot path has completed and one or more accelerated services have been completed by the first boot path circuitry 170 (e.g., the example audio circuitry 106 and the example network controller circuitry 108 have coordinated in a manner to cause a chime to be played), the first and second boot paths merge to complete any additional initialization activities in a manner consistent with default boot procedures. However, in the event of any conflict between the first boot path (e.g., the first boot path circuitry 170) and the second boot path (e.g., the second boot path circuitry 172), the example platform initialization circuitry 150 prioritizes the boot operations corresponding to the first boot path to use and/or otherwise power-up such resources before the resources associated with the second boot path.

The example platform initialization circuitry 150 includes example device communication circuitry 208 to facilitate peer-to-peer and/or otherwise inter-device communication for devices on the example SoC 102. In some examples, the device communication circuitry 208 monitors for instances when the audio circuitry 106 has completed processing of an audio chime (e.g., a data structure associated with a sound to be emitted on speakers of a vehicle infotainment system), and triggers offload engine circuitry for peer devices (e.g., the example audio offload engine circuitry 138 and the example network offload engine circuitry 140) to transfer data, as described in further detail below.

The example platform initialization circuitry 150 includes example microcontroller interface circuitry 210 to, in part, cause the example microcontroller 164 to packetize audio for network transmission over a network (e.g., a network of a vehicle communicatively connected to an infotainment system and/or speaker system). In some examples, the microcontroller interface circuitry 210 causes the example microcontroller 164 to store packetized payload data in the NVM 122 and inform the example MAC 104 that it may retrieve and/or otherwise fetch the payload therefrom when ready to transmit over the network.

The example platform initialization circuitry 150 includes example address redirect circuitry 212 to intercept network requests to DDR memory and redirect them to a memory corresponding to a subsystem of interest (e.g., the audio circuitry memory 136 of the example audio circuitry 106, the network memory 154 of the example network controller circuitry 108, etc.). As described above and in further detail below, because DDR memory has not yet been initialized, typical network communications with DDR memory address headers would fail to resolve.

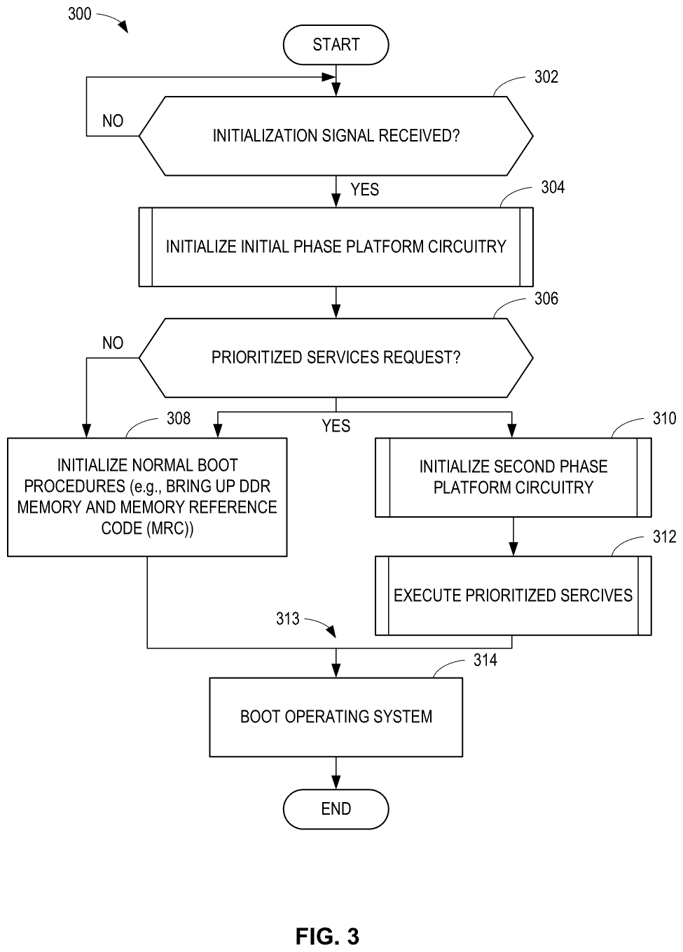

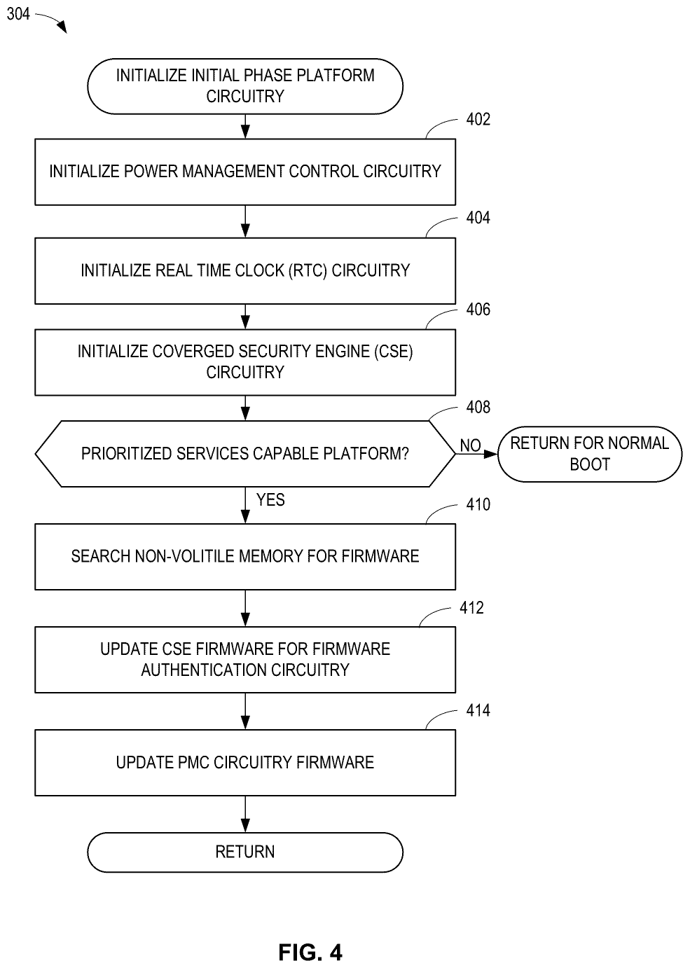

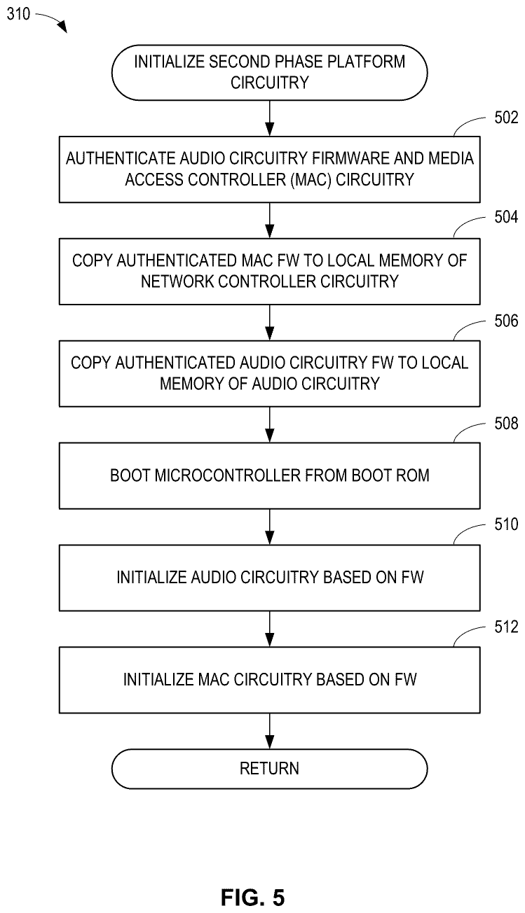

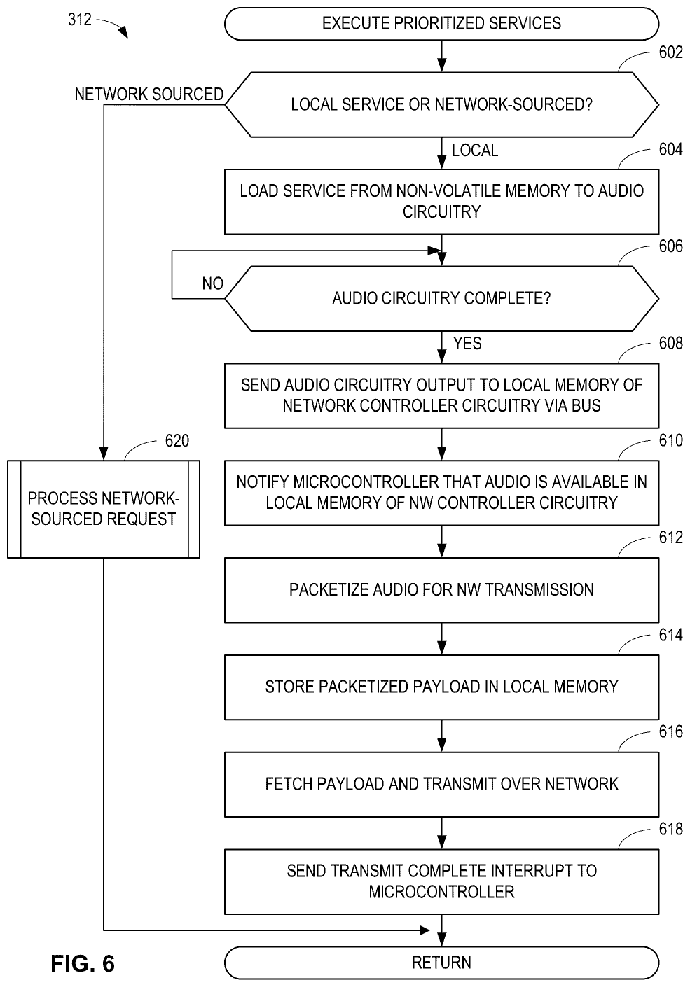

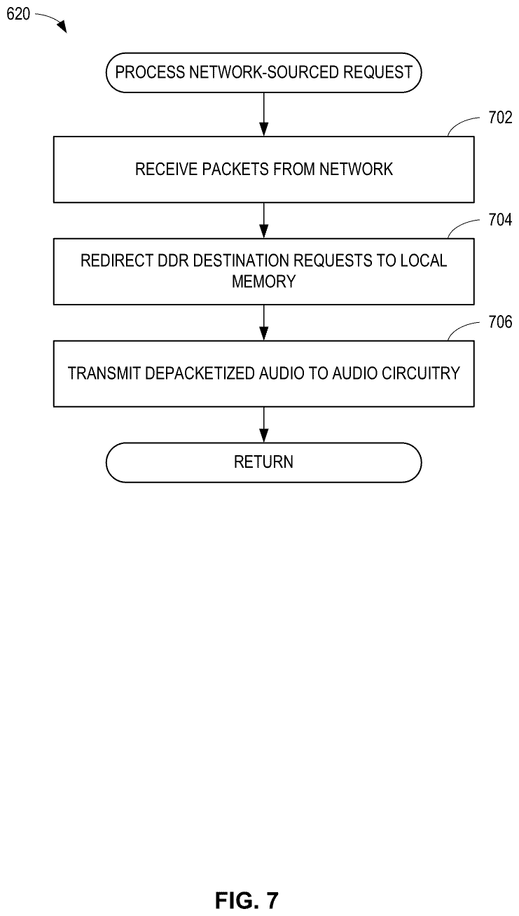

In some examples, the input circuitry 202 is instantiated by programmable circuitry executing input instructions and/or configured to perform operations such as those represented by FIGS. 3, 6 and 7. In some examples, the power management circuitry 204 is instantiated by programmable circuitry executing power management instructions and/or configured to perform operations such as those represented by FIGS. 3 and 4. In some examples, the firmware management circuitry 206 is instantiated by programmable circuitry executing firmware management instructions and/or configured to perform operations such as those represented by FIGS. 4 and 5. In some examples, the device communication circuitry 208 is instantiated by programmable circuitry executing device communication instructions and/or configured to perform operations such as those represented by FIGS. 6 and 7. In some examples, the microcontroller interface circuitry 210 is instantiated by programmable circuitry executing microcontroller interface instructions and/or configured to perform operations such as those represented by FIGS. 5 and 6. In some examples, the address redirect circuitry 212 is instantiated by programmable circuitry executing address redirection instructions and/or configured to perform operations such as those represented by FIG. 7. In some examples, the platform initialization circuitry 150 is instantiated by programmable circuitry executing platform initialization instructions and/or configured to perform operations such as those represented by FIGS. 3, 4 and 6.

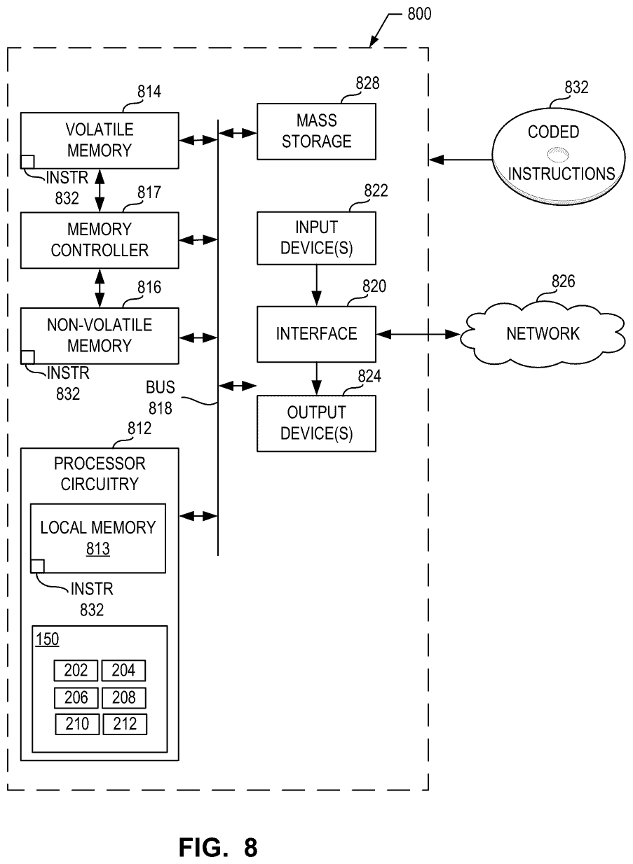

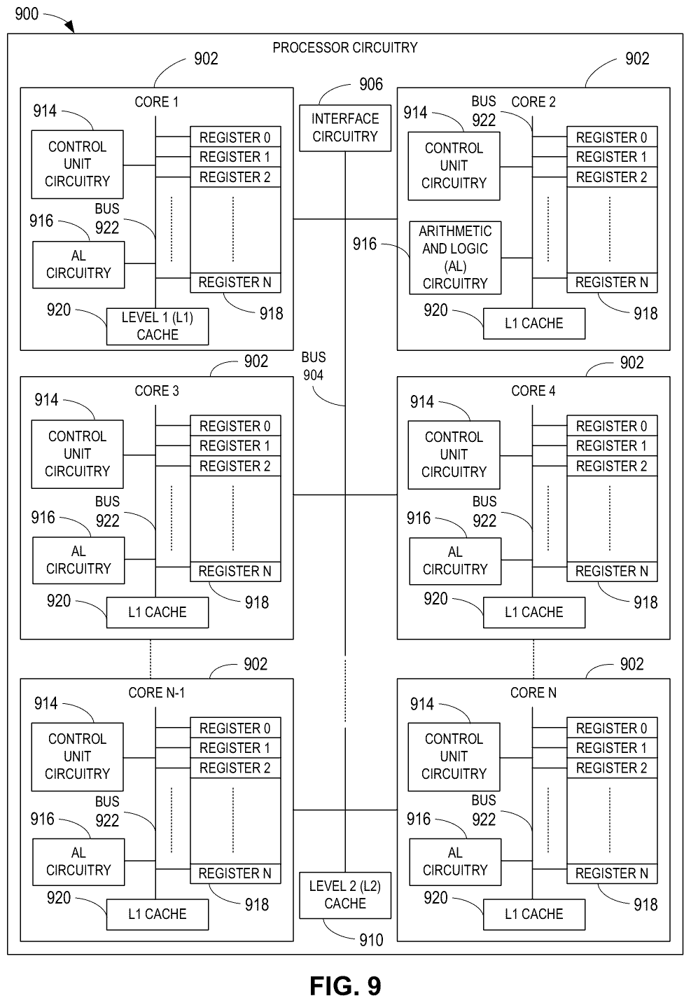

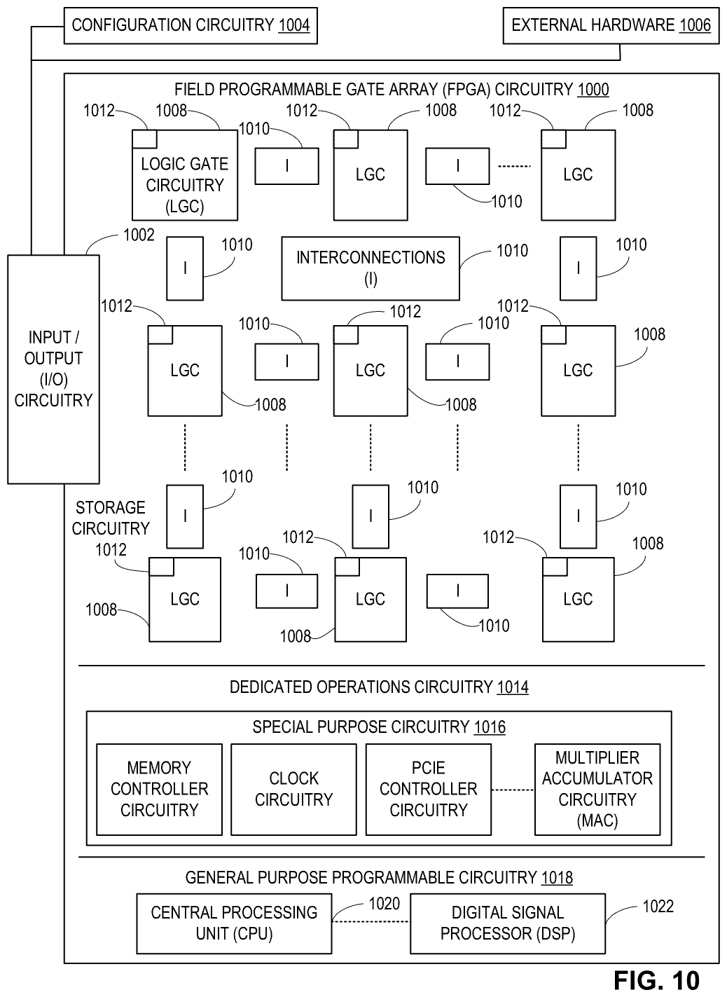

In some examples, the platform initialization circuitry 150 includes means for input management, means for power management, means for firmware management, means for device communication, means for microcontroller interfacing, means for address redirection, and means for platform initialization. For example, the means for input management may be implemented by input management circuitry 202, the means for power management may be implemented by power management circuitry 204, the means for firmware management may be implemented by firmware management circuitry 206, the means for device communication may be implemented by device communication circuitry 208, the means for microcontroller interfacing may be implemented by microcontroller interface circuitry 210, the means for address redirection may be implemented by address redirect circuitry 212, and the means for platform initialization may be implemented by platform initialization circuitry 150. In some examples, the aforementioned circuitry may be instantiated by programmable circuitry such as the example programmable circuitry 812 of FIG. 8. For instance, the aforementioned circuitry may be instantiated by the example microprocessor 900 of FIG. 9 executing machine executable instructions such as those implemented by at least the blocks of FIGS. 3-7. In some examples, the aforementioned circuitry may be instantiated by hardware logic circuitry, which may be implemented by an ASIC, XPU, or the FPGA circuitry 1000 of FIG. 10 configured and/or structured to perform operations corresponding to the machine-readable instructions. Additionally or alternatively, the platform initialization circuitry 150 may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In operation, the example SoC 102 and the example platform initialization circuitry 150 invokes the example input circuitry 202 to determine whether an initialization signal has been received. As described above, initialization signals may originate from a user's interaction with a vehicle ignition switch. In response to detecting such a signal, the platform initialization circuitry 150 performs operations to initialize an initial phase (e.g., a first phase) of SoC circuitry and/or devices. In particular, the platform initialization circuitry 150 invokes and/or otherwise instantiates the power management circuitry 204, which in turn initializes real time clock (RTC) circuitry and the example firmware authentication circuitry 130 (sometimes referred to as the CSE). Even in circumstances where a forked boot and/or service is not required, the RTC circuitry and firmware authentication circuitry 130 are utilized for any SoC boot process. If no such forked boot operation to execute one or more prioritized services is needed, the example SoC 102 boots under a normal and/or otherwise default manner. As described above, a forked boot operation may be signaled and/or otherwise caused in response to the example platform initialization circuitry 150 detecting a boot flag stored in the example NVM 122. Additionally or alternatively, in some examples disclosed herein the boot flag and/or other indicator to cause the forked boot operation may be stored in the platform initialization circuitry 150. However, if the platform initialization circuitry 150 determines that a prioritized service is to be executed, the firmware management circuitry 206 searches the NVM 122 for firmware to be used. As described above, a typical SoC boot utilizes DDR memory during device-to-device communication via the example inter circuit bus 116, but in circumstances where a service (e.g., a chime) is to occur in a threshold period of time the DDR memory is not available during early boot stages.

The example firmware management circuitry 206 updates the CSE 130 firmware so that it knows to look for firmware source files in the NVM 122. Any firmware detected in the NVM 122 is transferred to a memory of the device on which that firmware is to be initialized. For instance, if firmware associated with the audio circuitry 106 is found in the NVM 122, the firmware management circuitry 206 transfers that audio-focused firmware to the audio circuitry memory 136. Likewise, if firmware associated with the MAC 104 is found in the NVM 122, the firmware management circuitry 206 transfers that network-based firmware to the network memory 154. Additionally, the firmware management circuitry 206 updates the firmware for the PMC circuitry 132 so that specific device(s) and/or circuit(s) may be powered up in a manner consistent with forked boot operations having a first boot path (primary) and a second boot path (secondary). In particular, the updated firmware for the PMC circuitry 132 specifies an augmented boot schedule to prioritize those devices and/or circuitry that are needed to enable and/or otherwise facilitate the service to be accelerated.

The example platform initialization circuitry 150 initializes a second phase/portion and a third phase/portion of SoC circuitry and/or devices after the first phase is initialized. The second portion corresponds to circuitry needed to facilitate the accelerated service of interest (e.g., playing an audio chime), while the third portion corresponds to relatively lower prioritized circuitry associated with a default boot operation(s). In particular, the example firmware management circuitry 206 invokes the example firmware authentication circuitry 130 to authenticate audio circuitry firmware and MAC circuitry firmware stored in the audio circuitry memory 136 and the network memory 154, respectively (e.g., circuitry associated with the second portion). The firmware management circuitry 206 causes the microcontroller 164 to boot from the example boot ROM 166, and then causes the authenticated firmware to be executed for causing initialization processes corresponding to respective devices/circuits. The second portion of SoC circuitry activation corresponds to prioritized subsystem circuitry of the SoC 102 that are directly related to facilitating the accelerated service. At least one objective of some examples disclosed herein is to complete initialization processes and execute the prioritized subsystem circuitry of the SoC 102 while a forked (e.g., parallel) boot branch proceeds with initialization processes corresponding to relatively less important subsystem circuitry (e.g., tertiary subsystem circuitry) that is not relevant and/or otherwise associated with executing the accelerated service of interest. As such, any tasks associated with the tertiary subsystem circuitry of the SoC 102 will execute after the prioritized task(s) (e.g., playing a chime) corresponding to the second portion of SoC circuitry activation.

The example input circuitry 202 determines whether a request for services of the SoC is originating from a data file or service files stored on the NVM 122, or whether a request is originating from a network connected to the MAC 104. In some examples, the data file or service file stored on the NVM 122 (e.g., the chime 124) is referred to as a “local request,” and the example platform initialization circuitry 150 loads the service (e.g., the chime 124) from the NVM 122 to the audio circuitry 106. In the event the service is associated with a data file or service file (e.g., the chime 124), then the platform initialization circuitry 150 loads the service from the NVM 122 to the audio circuitry 106, and the device communication circuitry 208 determines when the audio circuitry 106 has completed its processing of the service file (e.g., the chime 124). In some examples, the audio circuitry 106 processes the chime 124 with DSP circuitry 134 and, when completed, the device communication circuitry 208 invokes the example audio offload engine circuitry 138 to send and/or otherwise transmit the processed audio data to the example network offload engine circuitry 140 of the example network controller circuitry 108. In some examples the example audio offload engine circuitry 138 and the example network offload engine circuitry 140 send and receive data via the example inter circuit bus 116 so that any communication between the audio circuitry 106 and the network controller circuitry 108 occur in a peer-to-peer manner without any need for DDR memory participation (which is not yet ready for use at the early stages of boot). Additionally, in response to receiving the processed audio data, the device communication circuitry causes the network offload engine circuitry 140 to store the processed audio data in the network memory 154 as a raw payload 160.

The example device communication circuitry 208 invokes and/or otherwise notifies the example microcontroller 164 that the audio data is available in the network memory 154 as the raw payload 160, and the microcontroller 164 retrieves it for further processing. In particular, the microcontroller 164 packetizes the audio for network transmission and/or otherwise prepares packets in a manner suitable for the MAC 104. For instance, applied firmware enables the microcontroller 164 to perform packetization in a manner that complies with any type of desired standard, such as the example AVB standard regulated by IEEE 1722. After such packetization, the microcontroller 164 stores the packetized payload back to the network memory 154 as the AVB payload 162.

The example device communication circuitry 208 fetches the AVB payload 162 from the network memory 154 on behalf of the MAC 104 and transmits the packet(s) over any connected network (e.g., an infotainment network of a vehicle). Additionally, the example device communication circuitry 208 sends a notification interrupt (e.g., a transmission complete interrupt) to the example microcontroller 164.

In some examples, the input circuitry 202 determines that the service request is derived from one or more networks connected to the example MAC 104. The example MAC 104 receives the packets from the network and the example address redirect circuitry 212 determines whether the packets include destination information associated with a destination that may not be available, such as DDR memory that has not yet been initialized. The address redirect circuitry 212 redirects such network communications to an alternate destination source, such as the example network memory 154 (e.g., as an AVB payload 162). In some examples, the microcontroller 164 depacketizes the network communication data and the device communication circuitry 208 invokes the example network offload engine circuitry 140 to transfer payload data to the example audio circuitry 106 via the example inter circuit bus 116. In some examples, the audio circuitry 106 may have a connected speaker to play any audio data that may be embedded in the network payload.

After the example service has been executed, such as the chime being played within the threshold period of time, the example platform initialization circuitry 150 continues to boot the SoC 102 to the point where the OS is functioning.

While an example manner of implementing the platform initialization circuitry 150 of FIG. 1 is illustrated in FIG. 2, one or more of the elements, processes, and/or devices illustrated in FIG. 2 may be combined, divided, re-arranged, omitted, eliminated, and/or implemented in any other way. Further, the example input circuitry 202, the example power management circuitry 204, the example firmware management circuitry 206, the example device communication circuitry 208, the example microcontroller interface circuitry 210, the example address redirect circuitry 212, the example microcontroller 164, the example audio offload engine circuitry 138, the example network offload engine circuitry 140, the example address redirect circuitry 168, and/or, more generally, the example platform initialization circuitry 150 of FIG. 2, may be implemented by hardware alone or by hardware in combination with software and/or firmware. Thus, for example, any of the example input circuitry 202, the example power management circuitry 204, the example firmware management circuitry 206, the example device communication circuitry 208, the example microcontroller interface circuitry 210, the example address redirect circuitry 212, the example microcontroller 164, the example audio offload engine circuitry 138, the example network offload engine circuitry 140, the example address redirect circuitry 168, and/or, more generally, the example platform initialization circuitry 150, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example platform initialization circuitry 150 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine-readable instructions, which may be executed by programmable circuitry to implement and/or instantiate the platform initialization circuitry 150 of FIG. 2 and/or representative of example operations which may be performed by programmable circuitry to implement and/or instantiate the platform initialization circuitry 150 of FIG. 2, are shown in FIGS. 3-7. The machine-readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-7, many other methods of implementing the example platform initialization circuitry 150 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-7 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by programmable circuitry to accelerate service execution. The example machine-readable instructions and/or the example operations 300 of FIG. 3 begin at block 302, at which the example input circuitry 202 determines whether an initialization signal has been received. As described above, the initialization signal may be one or more signals from an ignition switch of a vehicle. While some examples disclosed herein relate to use case scenarios in the automotive industry, examples disclosed herein to accelerate service execution are not limited thereto. For instance, the initialization signal may be associated with an emergency stop (E-Stop) button activated in a manufacturing environment to quickly execute urgent and, in some cases, life saving services.

In response to the input circuitry 202 determining that an initialization signal has been received (block 302), the example platform initialization circuitry 150 initializes initial phase platform circuitry (block 304) as described above and in further detail below. The example platform initialization circuitry 150 determines whether one or more services are to be prioritized and/or otherwise accelerated (block 306) and, if not, the example power management circuitry 204 initializes normal (e.g., default) boot operations for the example SoC 102 (block 308). In some examples, default and/or otherwise normal boot procedures include initializing DDR memory in conjunction with memory reference code (MRC) operations.

However, in the event the example platform initialization circuitry 150 determines one or more services is to be executed in an accelerated manner (block 306), then the example platform initialization circuitry 150 causes a fork boot operation (block 306=YES) in which (a) a second phase of platform circuitry is initialized that is needed to facilitate the one or more services (block 310) and (b) normal boot procedures occur with respect to non-prioritized circuitry and/or devices of the SoC device 102 (block 308). The example platform initialization circuitry 150 executes those services corresponding to the second phase platform circuitry (block 312) and the fork boot operation merges back together (see 313) before the OS is booted (block 314) as described in further detail below.

FIG. 4 is a flowchart illustrating additional detail of block 304 to initialize an initial phase of platform circuitry. In the illustrated example of FIG. 4, the power management circuitry 204 invokes and/or otherwise instantiates the power management control (PMC) circuitry 132 (block 402), which in turn causes completion of initialization processes corresponding to the RTC circuitry (block 404) and the example firmware authentication circuitry 130 (block 406). The example platform initialization circuitry 150 verifies whether normal boot or forked boot is to occur (block 408), and control returns to block 306 in the event a normal boot is to proceed. On the other hand, if the platform initialization circuitry 150 determines that a forked boot is to occur so that one or more services can be executed before the entirety of the SoC device 102 is fully operational (block 408), then the example firmware management circuitry 206 searches the NVM 122 for updated firmware that may be needed for one or more devices and/or circuitry (block 410). The example firmware management circuitry 206 updates firmware for the firmware authentication circuitry 130 (block 412), and updates firmware for the PMC circuitry 132 (block 414).

FIG. 5 is a flowchart illustrating additional detail of block 310 to complete initialization processes corresponding to the second phase platform circuitry. In the illustrated example of FIG. 5, the example firmware management circuitry 206 authenticates firmware associated with the audio circuitry 106 and the network controller circuitry 108 (block 502), which is located in the NVM 122. In some examples disclosed herein, the firmware associated with the network controller circuitry 108 includes firmware for the example MAC circuitry 104. Once the firmware stored in the NVM 122 has been confirmed authentic and/or otherwise safe, the firmware management circuitry 206 copies such authenticated firmware to a storage/memory location corresponding to the respective device/circuitry. In particular, the firmware management circuitry 206 copies the authenticated MAC firmware from the NVM 122 to the network memory 154 (block 504) so that MAC driver functionalities are available for implementation (e.g., and the example microcontroller 164 will later have access to that firmware for updating purposes). The firmware management circuitry 206 also copies the authenticated audio circuitry firmware from the NVM 122 to the audio circuitry memory 136 (block 506). The firmware management circuitry 206 causes the microcontroller 164 to begin its boot process, which is based on the example boot ROM 166 (block 508). Additionally, the firmware management circuitry 206 causes the firmware to be initialized on the audio circuitry 106 based on the authenticated firmware stored in the audio circuitry memory 136 (block 510). Similarly, the example microcontroller interface circuitry 210 causes the MAC circuitry to be updated based on the firmware stored in the example network memory 154 (block 512). In some examples, the firmware corresponding to the MAC circuitry 104 facilitates any number of NIC driver functions such as, but not limited to, descriptor ring formation and data flow control. Control then returns to block 312 of FIG. 3.

FIG. 6 is a flowchart including additional detail corresponding to block 312 of FIG. 3 to execute prioritized services. In the illustrated example of FIG. 6, the input circuitry 202 determines whether a request is a local service identified from the NVM 122 (e.g., a chime service 124), or a service identified from a connected network (block 602). In the event of a local service identified in the NVM 122, the platform initialization circuitry 150 loads the service (e.g., a data file and/or other instructions, such as the chime service 124) from the NVM 122 to the audio circuitry memory 136 of the example audio circuitry 106 (block 604). The example device communication circuitry 208 determines when the audio circuitry 106 has completed its operations on the chime service 124 (block 606) (e.g., one or more DSP operations performed by the example DSP circuitry 134). When complete, the device communication circuitry 208 invokes the audio offload engine circuitry 138 to send the processed audio chime to the example network offload engine circuitry 140 using the example inter circuit bus 116 (block 608). In particular, rather than typical approaches of device-to-device communication that require data written from a first device to DDR memory and a data request from a second device from the DDR memory, the audio offload engine circuitry 138 reduces communication latency by enabling a direct communication between the audio circuitry 106 and the network controller circuitry 108 via the inter circuit bus 116. When received, the network offload engine circuitry 140 stores the audio chime in the network memory 154 (e.g., as the raw payload 160) without any involvement with or by DDR memory (e.g., memory 114). As described above, examples disclosed herein overcome the inability of device-to-device communication from occurring before the DDR memory (e.g., the memory 114) has been initialized and operational by instead utilizing the example audio offload engine circuitry 138 and network offload engine circuitry 140 over the inter circuit bus 116. The example device communication circuitry 208 also causes the network offload engine circuitry 140 to notify the microcontroller 164 that the peer-to-peer data transfer has been completed and that the processed audio chime 124 is waiting in the network memory 154 (block 610).

The example microcontroller interface circuitry 210 causes the microcontroller 164 to packetize audio (currently stored as raw payload data 160) for network transmission (block 612), such as formatting the packets to confirm to one or more standards of interest. Once the payload data has been packetized and/or otherwise formatted, the microcontroller stores the payload data back to the network memory 154 as AVB payload 162 (block 614). At this point, the AVB payload 162 is ready for the MAC 104 to fetch and transmit. As such, the example device communication circuitry 208 informs the MAC 104 that the AVB payload 162 may be retrieved and transmitted over the network (block 616). After the AVB payload 162 has been transmitted over the network, the device communication circuitry 208 sends a transmit complete interrupt message to the example microcontroller 164 (block 618). Control then returns to block 314 of FIG. 3.

FIG. 7 is a flowchart of additional detail corresponding to block 620 of FIG. 6 to process a network-sourced request for services. In the illustrated example of FIG. 7, the example input circuitry 202 determines that packets have been retrieved and/or otherwise received via the MAC 104 from one or more connected networks (block 702). The example address redirect circuitry 212 intercepts and/or otherwise encapsulates retrieved network packets that contain DDR destination address information and redirects storage of such packet payload information to the example network memory 154 (block 704). As described above, because the example SoC device 102 is not fully booted, entities outside the SoC device 102 are unaware that the SoC device 102 is not yet ready to receive normal network packets, which include DDR destination addresses. As such, the example address redirect circuitry 212 allows such communications to survive by storing corresponding payload data in a local memory (e.g., network memory 154) that is available. However, even in the event that DDR is ready and/or the example SoC device 102 is fully booted, the example address redirect circuitry 212 intercepts and/or otherwise encapsulates retrieved network packets to improve end-to-end latency in network requests (e.g., audio output requests). For instance, audio requests received from the network may be intercepted and/or otherwise redirected to the example audio circuitry instead of going to and/or otherwise through DDR, thereby reducing a latency in the audio being played and/or otherwise rendered. The example device communication circuitry 208 solicits the assistance of the example network offload engine circuitry 140 to retrieve the payload from the network memory 154 (e.g., depacketized payload information) and transmits it to the corresponding audio offload engine circuitry 138 via the example inter circuit bus 116 (block 706). As such, the example audio circuitry 106 can further process the received payload data, such as audio that is to be processed before being sent back to the network for transmission to an infotainment system.

FIG. 8 is a block diagram of an example programmable circuitry platform 800 structured to execute and/or instantiate the example machine-readable instructions and/or the example operations of FIGS. 3-7 to implement the platform initialization circuitry 150 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example input circuitry 202, the example power management circuitry 204, the example firmware management circuitry 206, the example device communication circuitry 208, the example microcontroller interface circuitry 210, the example address redirect circuitry 212, the example microcontroller 164, the example audio offload engine circuitry 138, the example network offload engine circuitry 140, the example address redirect circuitry 168, and/or, more generally, the example platform initialization circuitry 150 of FIG. 2.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 3-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 3-7 to effectively instantiate the circuitry of FIG. 2 as logic circuits to perform operations corresponding to those machine-readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 3-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 3-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 3-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-7. As such, the FPGA circuitry 1000 may be configured and/or structured to effectively instantiate some or all of the operations/functions corresponding to the machine-readable instructions of the flowchart(s) of FIGS. 3-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 3-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 3-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 3-7 to perform first operation(s)/function(s), the FPGA circuitry 1000 of FIG. 10 may be configured and/or structured to perform second operation(s)/function(s) corresponding to a second portion of the machine-readable instructions represented by the flowcharts of FIGS. 3-7, and/or an ASIC may be configured and/or structured to perform third operation(s)/function(s) corresponding to a third portion of the machine-readable instructions represented by the flowcharts of FIGS. 3-7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. [ER-Diagram] may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

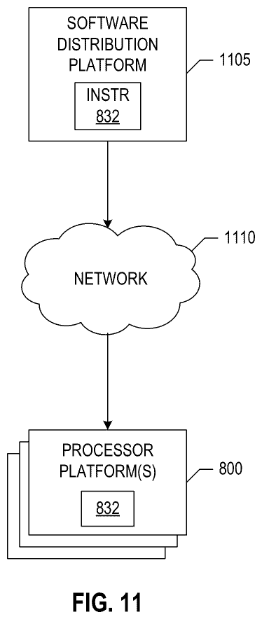

A block diagram illustrating an example software distribution platform 1105 to distribute software such as the example machine-readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine-readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine-readable instructions 832, which may correspond to the example machine-readable instructions of FIGS. 3-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 832 from the software distribution platform 1105. For example, the software, which may correspond to the example machine-readable instructions of FIGS. 3-7, may be downloaded to the example programmable circuitry platform 800, which is to execute the machine-readable instructions 832 to implement the platform initialization circuitry 150. In some examples, one or more servers of the software distribution platform 1105 periodically offer, transmit, and/or force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time within 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that some example systems, apparatus, articles of manufacture, and methods have been disclosed that accelerate service execution for completion in a pre-boot timeframe. Some examples disclosed herein enable emergency services to execute and/or otherwise deploy before a computing platform, such as an SoC, is fully booted and/or operational. Some examples disclosed herein overcome limitations of known computing platforms that rely on fully operational DDR memory for peer-to-peer and/or inter-device communication. Some examples disclosed herein facilitate a forked boot flow. In such examples, some portions of an SoC may be initialized that directly impact an ability to execute the emergency service, while relatively less urgent SoC circuitry is booted normally or delayed. Disclosed systems, apparatus, articles of manufacture, and methods improve the efficiency of using a computing device by enabling execution of services faster than known systems, thereby improving operation of a machine (e.g., operation(s) related to safety and/or industry standard compliance). Disclosed systems, apparatus, articles of manufacture, and methods are accordingly directed to one or more improvement(s) in the operation of a machine such as a computer, a vehicle, and/or other electronic and/or mechanical device.

Example methods, apparatus, systems, and articles of manufacture to accelerate service execution are disclosed herein. Further examples and combinations thereof include the following:

Example 1 includes a device comprising first circuitry to begin initialization during a boot time period, and second circuitry to complete initialization before the first circuitry, the second circuitry including audio circuitry and networking circuitry to perform a service before expiration of the boot time period.

Example 2 includes the device as defined in example 1, wherein the service includes playing a chime.

Example 3 includes the device as defined in any of examples 1 or 2, wherein the device includes an integrated circuit package.

Example 4 includes the device as defined in example 3, wherein the integrated circuit package includes a system on chip (SoC).

Example 5 includes the device as defined in any of examples 1, 2, 3 or 4 wherein the initialization of the first circuitry includes a basic input/output system (BIOS) initialization.

Example 6 includes the device as defined in any of examples 1, 2, 3, 4 or 5, wherein the audio circuitry is to play an audio chime prior to initialization associated with an operating system of the device.

Example 7 includes the device as defined in example 1, wherein the second circuitry is to initiate network communication services with the networking circuitry.

Example 8 includes the device as defined in example 1, wherein the second circuitry is to transfer audio data from a flash memory to a memory of the audio circuitry.

Example 9 includes the device as defined in any of examples 1, 2, 3, 5, 6, 7 or 8, wherein the service includes retrieving a chime from non-volatile memory, processing the chime with audio circuitry, transmitting the processed chime to networking circuitry, and transmitting the processed chime to an infotainment system via the networking circuitry.

Example 10 includes the device as defined in example 9, wherein the audio circuitry is to apply digital signal processing (DSP) operations to the chime retrieved from the non-volatile memory.

Example 11 includes the device as defined in example 9, wherein the audio circuitry includes audio offload engine circuitry, and the networking circuitry includes network offload engine circuitry.

Example 12 includes the device as defined in example 11, wherein the audio offload engine circuitry is to establish a direct communication path to the network offload engine circuitry via an inter circuit bus.

Example 13 includes a device comprising platform initialization circuitry to initiate a forked boot flow, first circuitry to be initialized via a first fork of the forked boot flow, and second circuitry to be initialized via a second fork of the forked boot flow.

Example 14 includes the device as defined in example 13, wherein the device includes an integrated circuit (IC) package.

Example 15 includes the device as defined in any of examples 13 or 14, wherein the IC package includes a system on chip (SoC).

Example 16 includes the device as defined in any of examples 13, 14 or 15, wherein the platform initialization circuitry is to cause the first circuitry to execute a service during the first fork of the forked boot flow, and cause the second circuitry to adjust an order of power initialization corresponding to sub-circuits associated with the device during the second fork of the forked boot flow.

Example 17 includes the device as defined in example 16, wherein the platform initialization circuitry is to identify ones of the sub-circuits of the device associated with the service, and adjust the order of power initialization based on a prioritization of the identified ones of the sub-circuits.

Example 18 includes the device as defined in example 13, wherein the platform initialization circuitry is to retrieve firmware corresponding to sub-circuits associated with the first circuitry.

Example 19 includes the device as defined in example 18, wherein the platform initialization circuitry is to execute the firmware to configure ones of the sub-circuits to communicate via an inter circuit bus.

Example 20 includes the device as defined in example 19, wherein the platform initialization circuitry is to cause a first one of the ones of the sub-circuits to transmit data to a second one of the ones of the sub-circuits via the inter circuit bus.

Example 21 includes the device as defined in example 20, wherein the platform initialization circuitry is to cause a bypass of double data rate (DDR) memory access during the transmission of data from the first one of the ones of the sub-circuits to the second one of the ones of the sub-circuits.

Example 22 includes the device as defined in example 13, wherein the first circuitry includes audio circuitry and network circuitry, the platform initialization circuitry to complete initialization of the audio circuitry and the network circuitry based on firmware stored in non-volatile memory (NVM), cause the audio circuitry to process audio data obtained from the NVM, cause the audio circuitry to transmit the processed audio data to the network circuitry via an inter circuit bus, and cause the network circuitry to transmit the processed audio data to an infotainment system.

Example 23 includes a non-transitory computer readable medium comprising machine readable instructions that, when executed, cause programmable circuitry to at least begin initialization of first circuitry during a boot time period, and complete initialization of second circuitry before the first circuitry, the second circuitry to perform a service before expiration of the boot time period.

Example 24 includes the non-transitory computer readable medium as defined in example 23, wherein the first circuitry and the second circuitry are part of an integrated circuit (IC) package.

Example 25 includes the non-transitory computer readable medium as defined in example 24, wherein the IC package is a system-on-chip (SoC).

Example 26 includes the non-transitory computer readable medium of any of examples 23, 24 or 25, wherein the machine readable instructions cause the programmable circuitry to initiate a basic input/output system (BIOS) initialization of the first circuitry.

Example 27 includes the non-transitory computer readable medium of example 23, wherein the second circuitry includes audio circuitry and networking circuitry, the machine readable instructions cause the programmable circuitry to initialize the audio circuitry with audio firmware and to initialize the networking circuitry with networking firmware.

Example 28 includes the non-transitory computer readable medium of example 27, wherein the machine readable instructions cause the programmable circuitry to play an audio chime with the second circuitry prior to initialization of an operating system associated with the first circuitry.

Example 29 includes the non-transitory computer readable medium of example 27, wherein the machine readable instructions cause the programmable circuitry to transfer data between the audio circuitry and the networking circuitry via an inter circuit bus.

Example 30 includes the non-transitory computer readable medium of example 27, wherein the machine readable instructions cause the programmable circuitry to obtain audio data from non-volatile memory, invoke audio circuitry to process the audio data, invoke the audio circuitry to transmit the processed audio data to networking circuitry via an inter circuit bus, and invoke the networking circuitry to transmit the processed audio data to a speaker system.

Example 31 includes a system comprising means for firmware management to authenticate firmware corresponding to first circuitry, means for power management to provide power to portions of the first circuitry based on the authenticated firmware, and means for platform initialization to execute a task with the portions of the first circuitry, and initialize second circuitry during execution of the task, the second circuitry unassociated with the task.

Example 32 includes the system as defined in example 31, wherein the means for platform initialization invokes a basic input/output system (BIOS) initialization of the second circuitry during execution of the task.

Example 33 includes the system as defined in example 31, wherein the portions of the first circuitry include audio circuitry and networking circuitry.

Example 34 includes the system as defined in example 33, wherein the means for platform initialization cause the audio circuitry to play an audio chime prior to completion of initialization of the second circuitry.

Example 35 includes the system as defined in example 33, further including means for device communication to transfer data between the audio circuitry and the networking circuitry without external memory access attempts.

Example 36 includes the system as defined in example 33, further including means for address redirection to re-route memory access requests from a first memory to a second memory, the second memory within the networking circuitry and the first memory external to the networking circuitry. The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A system comprising:
first circuitry to initialize during a boot time period; and
at least one of audio circuitry and networking circuitry to complete initialization and perform a service before expiration of the boot time period.

2. The system as defined in claim 1, wherein the service includes playing a chime.

3. (canceled)

4. The system as defined in claim 1, wherein the system includes a system on chip (SoC).

5. (canceled)

6. The system as defined in claim 1, wherein the audio circuitry is to play an audio chime prior to initialization of an operating system associated with the system.

7. The system as defined in claim 1, wherein the networking circuitry is to initiate network communication services with an infotainment system.

8. The system as defined in claim 1, wherein the audio offload engine circuitry is to transfer audio data from a flash memory to a memory of the audio circuitry.

9. The system as defined in claim 1, wherein the service includes:
retrieving a chime from non-volatile memory;
processing the chime with audio circuitry;
transmitting the processed chime to networking circuitry; and
transmitting the processed chime to an infotainment system via the networking circuitry.

10. The system as defined in claim 9, wherein the audio circuitry is to apply digital signal processing (DSP) operations to the chime retrieved from the non-volatile memory.

11. The system as defined in claim 9, wherein the audio circuitry includes audio offload engine circuitry, and the networking circuitry includes network offload engine circuitry.

12. The system as defined in claim 11, wherein the audio offload engine circuitry is to establish a direct communication path to the network offload engine circuitry via an inter circuit bus.

13. A system comprising:
platform initialization circuitry to initiate a forked boot flow;
first circuitry to be initialized via a first fork of the forked boot flow; and
second circuitry to be initialized via a second fork of the forked boot flow.

14.-15. (canceled)

16. The system as defined in claim 13, wherein the platform initialization circuitry is to:
cause the first circuitry to execute a service during the first fork of the forked boot flow; and
cause the second circuitry to adjust an order of power initialization corresponding to sub-circuits associated with the system during the second fork of the forked boot flow.

17. The system as defined in claim 16, wherein the platform initialization circuitry is to:
identify ones of the sub-circuits of the system associated with the service; and
adjust the order of power initialization based on a prioritization of the identified ones of the sub-circuits.

18. The system as defined in claim 13, wherein the platform initialization circuitry is to retrieve firmware corresponding to sub-circuits associated with the first circuitry.

19. The system as defined in claim 18, wherein the platform initialization circuitry is to execute the firmware to configure ones of the sub-circuits to communicate via an inter circuit bus.

20. The system as defined in claim 19, wherein the platform initialization circuitry is to cause a first one of the ones of the sub-circuits to transmit data to a second one of the ones of the sub-circuits via the inter circuit bus.

21. (canceled)

22. The system as defined in claim 13, wherein the first circuitry includes audio circuitry and network circuitry, the platform initialization circuitry to:
complete initialization of the audio circuitry and the network circuitry based on firmware stored in non-volatile memory (NVM);
cause the audio circuitry to process audio data obtained from the NVM;
cause the audio circuitry to transmit the processed audio data to the network circuitry via an inter circuit bus; and
cause the network circuitry to transmit the processed audio data to an infotainment system.

23. A non-transitory computer readable medium comprising machine readable instructions that, when executed, cause programmable circuitry to at least:
begin initialization of first circuitry during a boot time period; and
complete initialization of at least one of audio circuitry and networking circuitry before expiration of the boot time period.

24.-26. (canceled)

27. The non-transitory computer readable medium of claim 23, wherein the machine readable instructions cause the programmable circuitry to initialize the audio circuitry with audio firmware and to initialize the networking circuitry with networking firmware.

28. The non-transitory computer readable medium of claim 27, wherein the machine readable instructions cause the programmable circuitry to play an audio chime with the audio circuitry prior to initialization of an operating system associated with the first circuitry.

29.-36. (canceled)
